(19) United States
(12) Patent Application Publication
(10) Pub. No.: US 2018/0006468 A1
(43) Pub. Date: Jan. 4, 2018

(54) METHOD AND DEVICE FOR THE FRAGMENTATION AND/OR WEAKENING OF A PIECE OF MATERIAL BY MEANS OF HIGH-VOLTAGE DISCHARGES

(71) Applicant: seIFrag AG, Kerzers (CH)

(72) Inventors: Johannes Käppeler, Laupen (CH); Marion Esther Morach, Lostorf (CH); Alexander Weh, Engen (DE); Reinhard Müller-Siebert, Bern (CH)

(21) Appl. No.: 15/543,758

(22) PCT Filed: Feb. 27, 2015
(86) PCT No.: PCT/CH2015/000031

§ 371 Date: Jul. 14, 2017

(51) Int. Cl. H02J 7/00

(52) U.S. Cl. CPC H02J 7/00

(57) ABSTRACT

A method for the fragmentation and/or weakening of a piece of material by means of high-voltage discharges includes immersing the piece of material in a process fluid, guiding the material past a matrix formed by a number of high-voltage electrodes, which are supplied with high-voltage pulses. As such, high-voltage disruptive discharges occur through the piece of material whilst same is guided past the matrix. The high-voltage electrodes can be moved independently from one another along movement axes running substantially perpendicular to the passing direction of the work piece. And the electrodes are moved whilst the piece of material is guided past and whilst the high-voltage disruptive discharges are generated, in such a way that each follows the contour of the piece of material at a determined distance and are thereby immersed in the process fluid.

### TECHNICAL FIELD

The invention relates to a method for fragmenting and/or weakening a material piece by means of high voltage discharges, a device for carrying out the method as well as the use of the device for fragmenting and/or weakening fiber composites according to the preambles of the independent claims.

### PRIOR ART

From the prior art it is known how to fragment a variety of materials by means of pulsed high voltage discharges or to weaken them in such a way that they can be fragmented easier in a subsequent mechanical fragmenting process.

This technology is not only used in raw material production for fragmenting brittle materials, e.g. ores or minerals carrying gemstones, but is increasingly also used in other technical fields, e.g. for fragmenting raw silicon bars in the semiconductor industry or for fragmenting electronic waste with the aim of recovering recycling material.

In general, the method is also excellently suitable for recycling materials which are difficult to decompose and components made of fiber composites, e.g. skis, snowboards, bodywork parts, wind power plant blades, etc. However, there is the problem here that the high voltage fragmenting installations available today require a certain piece size of the material to be processed, which can only be reached by work-intensive individual pre-fragmenting, which implies high costs and was until now opposed to an industrial use of this technology for recycling such objects.

### DESCRIPTION OF THE INVENTION

It is therefore the objective to provide methods and devices for fragmenting and/or weakening material pieces by means of high voltage discharges, with the aid of which even large material pieces, e.g. skis, snowboards, bodywork parts or wind power plant blades can be processed without a complex pre-fragmenting.

This objective is reached by the subject matters of the independent claims.

According to these, a first aspect of the invention relates to a method for fragmenting and/or weakening a material piece by means of high voltage discharges. According to this method, a material piece to be fragmented and/or weakened, immersed in a process liquid, is guided past a matrix of multiple high voltage electrodes, which are charged with high voltage pulses by one or more high voltage generators, such that high voltage punctures are generated through the material piece during passage of the latter by the matrix of high voltage electrodes. The high voltage electrodes of the matrix are shiftable independently from one another along shifting axes, which are parallel to one another and run at an angle, particularly substantially perpendicular, to the passage direction of the piece, and are shifted, during the guide of the material piece past the matrix of high voltage electrodes and the generation of high voltage punctures through the material piece, along their shifting axes in such a way that each of them follows the contour of the material piece at a certain distance or follows the contour of the material piece in contact with the surface of the latter and during this time is immersed in the process liquid. The shifting axes of the high voltage electrodes are preferably oriented vertically.

The method according to the invention makes it possible to fragment and/or weaken large material pieces with various shapes in a simple way and without complex pre-fragmenting.

Preferably, for guiding the material piece to fragment and/or weaken past the matrix of high voltage electrodes, it is guided past it substantially horizontally, particularly shifted. This brings the advantage that the process zone which is flooded with process liquid only has to be slightly higher than the largest thickness of the material piece, and that in case of a shift of the material piece the high voltage electrode matrix can be stationary.

In the latter case of a “shift” of the material piece, the material piece is guided past the matrix of high voltage electrodes by means of a transport installation, preferably by means of a conveyor belt or a conveyor chain. In this way the material piece can be guided past the high voltage electrode matrix while being gradually weakened/fragmented in a controlled way and the fragmentation products or the weakened products, respectively, can be guided out of the process zone in a reliable way.

In a variant of the method it is preferred that the transport installation serves as counter electrode to the high voltage electrodes, which is preferably grounded, and high voltage punctures between the high voltage electrodes and the conveyor belt are generated through the material piece by charging the high voltage electrodes with the high voltage pulses. In this way it is possible act on the material piece to be fragmented and/or weakened in a particularly intense way, because the high voltage punctures puncture the material through its entire width.

In a further preferred embodiment of the method according to the invention, an own counter electrode is attributed to each high voltage electrode of the matrix, i.e. exclusively attributed to it, which is preferably grounded. This counter electrode is shifted along the shifting axis together with the respective high voltage electrode along its shifting axis and is arranged relatively to the respective high voltage electrode in such a way that high voltage punctures between the high voltage electrodes and the counter electrode are generated through the material piece by charging the respective high voltage electrode with the high voltage pulses. This results in the advantage that the puncture voltage is substantially decoupled from the thickness of the material piece to fragment and/or weaken, such that even thick material pieces or material pieces with strongly varying thicknesses can be processed without problems. A further advantage of this embodiment is particularly that it offers in the area of the process zone a highest possible design freedom with respect to the support surface or the transport installation, respectively, for the material to fragment and/or weaken, because this surface or installation, respectively, is not required here as counter electrode and therefore can be optimized in a better way with respect to other aspects.

Preferably, each high voltage electrode has an own high voltage generator, by means of which it is charged with high voltage pulses independently from the other high voltage electrodes. In this way it is possible to make sure that all zones of the high voltage electrode matrix have the same power or may equally be controlled in a targeted way, if, and if yes, with which power individual zones of the high voltage electrode matrix are operated.

It is furthermore advantageous that the respective high voltage generator is firmly connected to the high voltage electrode and is shifted along the shifting axis together with it. In this way, a secure connection between the respective high voltage generator and the respective high voltage electrode is ensured and the respective high voltage generator and the respective high voltage electrode can be replaced and maintained as a unit.

Preferably, during fragmentation and/or weakening of the material, the distance of each high voltage electrode of the high voltage electrode matrix to the contour of the material piece to fragment and/or weaken is continuously measured and the high voltage electrodes are shifted along their shifting axes in such a way that the measured distance of the electrodes corresponds to a certain reference distance.

It is also preferred that during fragmentation and/or weakening of the material it is continuously verified for each high voltage electrode if a material piece is located within a certain distance range to the respective high voltage electrode, and wherein the respective high voltage electrode is only charged with high voltage pulses when the verification results in that a material piece is located within this distance range.

These measures make it possible to optimize the process in terms of energy and/or of the effected power.

The distance measurement and/or the verification if material is present in a certain distance range is preferably done contactlessly, e.g. optically or by means of ultrasound.

In yet a further preferred embodiment of the method according to the invention, a material piece is fragmented and/or weakened, the extension of which is larger in passing direction, particularly many times larger, than the extension of the matrix of high voltage electrodes in this direction.

In yet a further preferred embodiment of the method according to the invention, a material piece is fragmented and/or weakened, which is a component or a piece of a component made of a fiber composite, preferably of glass-fiber-reinforced plastic or of carbon-fiber-reinforced plastic.

The advantages of the invention are particularly visible in case of such material pieces.

It is furthermore preferred for fragmentation and/or weakening of such large material pieces of fiber composite that the material is first weakened by charge with high voltage punctures by means of at least a part of the high voltage electrodes of the matrix during passage of the material piece past the matrix of high voltage electrodes, thereafter the weakened material is deviated by deforming it, advantageously in such a way that it is subsequently guided further substantially in horizontal direction, and the deviated weakened material is subsequently fragmented by further charging it with high voltage punctures, this being preferably also carried out by means of at least a part of the high voltage electrodes of the matrix.

Preferably, the material piece is supplied with a movement direction of the matrix of high voltage electrodes which is inclined downwards, is weakened, while passing past the matrix, by charge with high voltage punctures by means of at least a part of the high voltage electrodes of the matrix, and the weakened material is subsequently deviated by deforming it in such a way that it is transported further in a movement direction which is less inclined downwards, preferably in a substantially horizontal movement direction.

In this way it is possible to also process very long material pieces made of composite materials with devices according to the invention with relatively short and flat process liquid basins.

If the material piece is guided past the matrix of high voltage electrodes by means of a transport installation, it is preferred that the deviation is carried out by means of the transport installation. In this way it is possible to do without additional deviation installations.

Furthermore, in case material pieces made of composite fibers are fragmented or weakened, respectively, it is preferred to fragment the fiber composite such that the plastic parts are separated from the fibers. In this way it is possible to carry out a separation of the fibers from the plastic parts, which enables disposal suited to the materials and/or recycling, particularly of the fibers.

A second aspect of the invention relates to a device for carrying out the method according to the first aspect of the invention. According to the invention, the device comprises a matrix of multiple high voltage electrodes, which are shiftable independently from one another along preferably parallel, preferably vertically oriented, shifting axes.

Such a device allows to process large material pieces with different sizes and without complex pre-fragmentation according to the method according to the invention.

Preferably, each of the high voltage electrodes of the matrix has its own high voltage generator, by means of which it can be charged with high voltage pulses independently from the other high voltage electrodes. In this way, it is possible to make sure that all zones of the high voltage electrode matrix have the same power or it can be controlled in a targeted way if and by which power individual zones of the high voltage electrode matrix can be operated.

It is furthermore advantageous that the respective high voltage generator is firmly connected to high voltage electrode and is shifted along the shifting axis together with it. In this way, a secure connection between the respective high voltage generator and the respective high voltage electrode is provided and the high voltage generator and the high voltage electrode can be replaced and maintained as a unit.

Advantageously, the device further comprises a machine controller by means of which, in operation as intended during the passage of the material piece past the matrix of high voltage electrodes and the generation of high voltage punctures through the material piece, the high voltage electrodes can be shifted automatically along their shifting axes in such a way that each of them follows the contour of the material piece at a certain distance or each of them follows the contour of the material piece in contact with the surface of the material piece.

Preferably, this machine controller is additionally adapted to verify continuously for each high voltage electrode, in operation as intended during the passage of the material piece past the matrix of high voltage electrodes, if a material piece is located within a certain distance range to the respective high voltage electrode, and to omit charging the respective high voltage electrode with high voltage pulses if the verification results in that a material piece isn't located within this distance range.

The process can be optimized by these operation types of the machine controller.

In yet a further preferred embodiment, the device comprises a transport installation, preferably formed as a conveyor belt or conveyor chain, arranged in a basin filled with a process liquid, by means of which a material piece to be fragmented and/or weakened, immersed in process liquid, can be guided past the matrix of high voltage electrodes, in operation as intended, in a direction substantially perpendicular to the shifting axes of the high voltage electrodes. In this way, the material piece can be guided past the high voltage electrode matrix, while continuously weakening/fragmenting it, in a controlled way and the fragmentation products or the weakened products, respectively, may be guided out of the process zone in a secure and reliable way.

It is furthermore preferred that the device has a supply installation for the material to be fragmented and/or weakened, particularly formed as a roller ramp, by means of which this material to be fragmented and/or weakened is supplied into an area formed between the transport installation and the matrix of high voltage electrodes in a supply direction which is inclined downwards.

The supply direction of the supply installation is, preferably together with the transport direction of the transport installation, in a common vertical plane at an angle with respect to the transport direction of the transport installation, preferably at an angle greater than 15°.

In the last mentioned case it is further preferred that the device additionally comprises a hold-down device, e.g. with one or more pressure rollers, by means of which the material piece to be fragmented and/or weakened is secured against takeoff from the supply installation during the supply, in such a way that, in order to pass the entire area (process space) formed between the transport installation and the matrix of high voltage electrodes, it is deviated through the transport installation in this area by deformation.

In this way it is possible to also process long material pieces made of composite materials with devices according to the invention with relatively short and flat process liquid basins.

In a preferred alternative of the aforementioned preferred embodiment of the device with a transport installation, by means of which a material piece to be fragmented and/or weakened can be guided past the matrix of high voltage electrodes, the transport device serves as counter electrode to the high voltage electrodes in operation as intended, such that high voltage punctures between the high voltage electrodes and the conveyor belt are generated through the material piece to be fragmented and/or weakened. Such devices allow acting on the material piece to be fragmented and/or weakened in a particularly intense way, because high voltage punctures can be generated through the material across the entire material thickness.

In yet a further preferred embodiment of the device according to the invention, each high voltage electrode of the matrix has at least one own counter electrode which is preferably grounded and which can be shifted along its shifting axis together with this high voltage electrode and is arranged relatively to it such that high voltage punctures between the high voltage electrode and the counter electrode are generated through a material piece which is arranged adjacent to it by charging the respective high voltage electrode with the high voltage pulses. This results in the advantage that the puncture voltage is substantially decoupled from the thickness of the material piece to fragment and/or weaken, such that even thick material pieces or material pieces with strongly varying thicknesses can be processed without problems. A further advantage of this embodiment is particularly that it offers in the area of the process zone a highest possible design freedom with respect to the support surface or the transport installation, respectively, for the material to fragment and/or weaken, because this surface or installation, respectively, is not required here as counter electrode.

In a preferred alternative of the aforementioned preferred embodiment of the device with a transport installation, by means of which a material piece to be fragmented and/or weakened can be guided past the matrix of high voltage electrodes, the device has, arranged downstream of the matrix of high voltage electrodes as seen in transport direction of the transport installation, a separation installation for separating fiber-type and particle-type fragmentation products. In this way, after fragmentation of fiber composites, a separation of the fibers from the plastic parts is made possible, thereby allowing disposal suited to the materials and/or recycling, particularly of the fibers.

In yet a further preferred embodiment of the device according to the invention, the matrix of high voltage electrodes is formed by multiple rows of high voltage electrodes, which are arranged one after the other as seen in intended direction of passage of the material piece to be fragmented and/or weakened, wherein the high voltage electrodes are each shifted in case the rows are arranged directly one after the other. In this way, the distance of the high voltage electrodes as seen in intended direction of passage of the material piece to be fragmented and/or weakened can be minimized and thereby the action density can be maximized.

A third aspect of the invention relates to the use of the device according to the second aspect of the invention for fragmenting and/or weakening fiber composites, particularly glass-fiber-reinforced plastic or of carbon-fiber-reinforced plastic. In case of such uses, the advantages of the invention are particularly visible.

### SHORT DESCRIPTION OF THE DRAWINGS

Further embodiments, advantages and applications of the invention result from the dependent claims and from the now following description by the drawings. It is shown in:

FIG. 1 a vertical section through a first device according to the invention;

FIG. 2 a horizontal section through the first device according to the invention along the line A-A of FIG. 1;

FIG. 3 a vertical section through the first device according to the invention along the line B-B of FIG. 1 during fragmentation of a plate-type component;

FIG. 4 a view like FIG. 3 during fragmentation of a profiled component;

FIG. 5 a lateral view of one of the electrode arrangements of the first device according to the invention;

FIG. 6 a lateral view of an alternative of the high voltage electrode of FIG. 5;

FIG. 7 a view like in FIG. 1 of a third device according to the invention.

### WAYS OF CARRYING OUT THE INVENTION

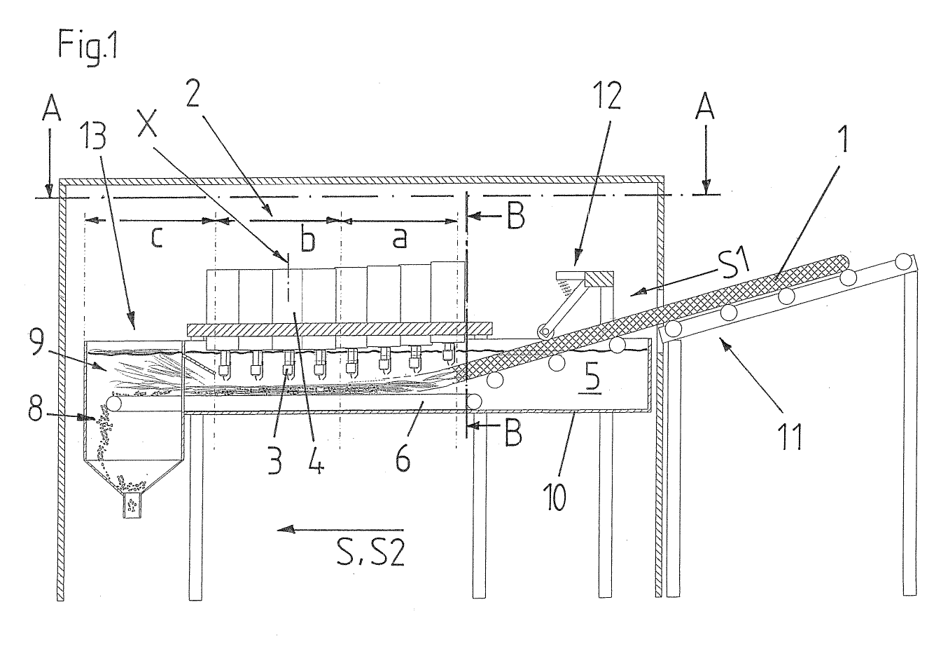

FIG. 1 shows a first device according to the invention for fragmenting large material pieces 1 of fiber composites in a vertical section along the material passage direction S.

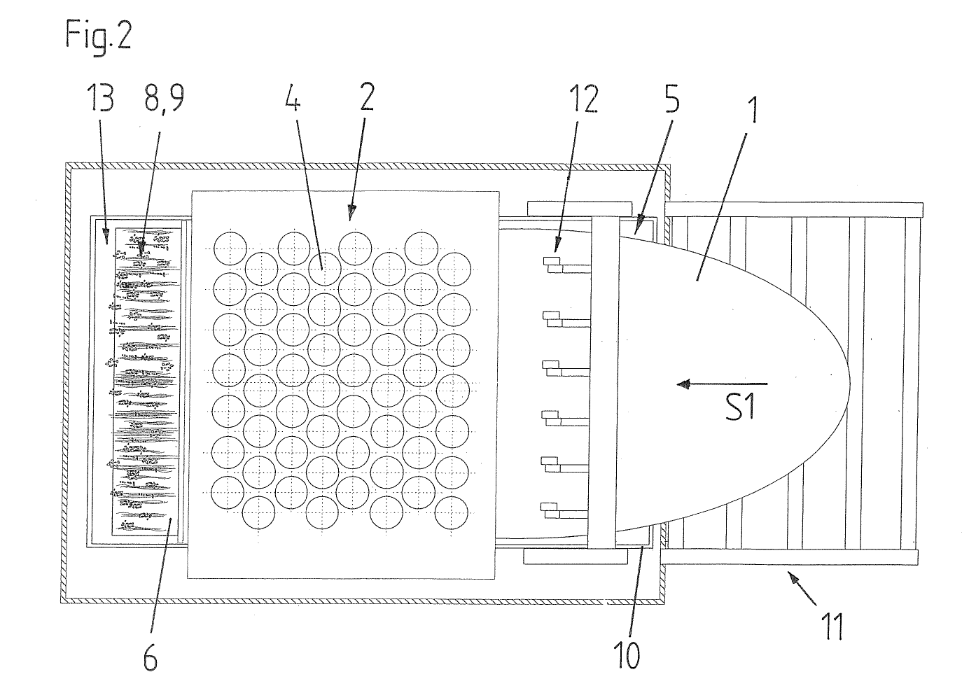

As can be seen together with FIG. 2, which shows a horizontal section through the device along the line A-A of FIG. 1, the core piece of the device consists of a matrix 2 with fifty six high voltage electrodes 3 (in the figures, only one of the high voltage electrodes has the reference 3 due to clarity reasons), which are arranged, in material passage direction S, in eight rows arranged one after the other, each having seven high voltage electrodes 3, wherein the high voltage electrodes 3 of rows arranged directly one behind the other are each arranged in a shifted way.

The high voltage electrodes 3 are shiftable independently from one another along parallel, vertically oriented shifting axes X (in the figures, only the shifting axis of one of the high voltage electrodes is drawn and has the reference X, due to clarity reasons).

Each one of the high voltage electrodes 3 has an own high voltage generator 4 (in the figures, only the high voltage generator of one of the high voltage electrodes has the reference 4, due to clarity reasons), by means of which it is charged with high voltage pulses, in the shown operation as intended, independently from the other high voltage electrodes 3. The high voltage generators 4 are each arranged directly above the respective high voltage electrode 3 attributed to it, they are firmly connected to the latter and they are shiftable along the shifting axis X of this high voltage electrode 3.

A conveyor belt 6 is arranged in a basin 10 flooded with water 5 (process liquid) below the matrix 2 of high voltage electrodes 3, by means of which the material piece 1 to be fragmented, in the present case a surf board 1 made of fiberglass-reinforced plastic, is guided past the high voltage electrodes 3 of the matrix 2 in material passage direction S, wherein the material in the area below the high voltage electrodes 3 is immersed in the water 5 located inside the basin 10, as well as the high voltage electrodes arranged above.

Furthermore, the device comprises a roller ramp 11, by means of which the material piece 1 to be fragmented is supplied into the process zone formed between the transport installation 6 and the matrix 2 of the high voltage electrodes 3 in a supply direction S1 which is inclined downwards, at an angle, lying in a vertical plane, to the transport direction S2 of the conveyor belt of about 15°.

A hold-down device 12 with multiple pressure rollers is arranged above the roller ramp 11, by means of which the material piece 1 to be fragmented is pressed on the roller ramp 11 during the supply, in such a way that, in order to pass the entire area between the conveyor belt 6 and the matrix 2 of high voltage electrodes 3, it is deviated in the front area of the process zone by the conveyor belt 6 from the supply direction S1 in the transport direction S2 of the conveyor belt 6 and deformed during this process.

A separation installation 13, by means of which fibers 9 are eliminated from the plastic particles 8, is arranged downstream from the matrix 2 of high voltage electrodes 3, as seen in material passage direction S or in transport direction S2 of the conveyor belt 6.

During passage through the process zone formed between the matrix 2 of high voltage electrodes 3 and the conveyor belt 6, first the firm mechanical structure of the material piece 1 is softened (weakened) in a first process zone section a, in order to enable the deviation of the material by the conveyor belt 6 from the supply direction S1 in the transport direction S2 of the conveyor belt 6 while deforming the material. Thereafter, the material is fragmented in a second process zone section b to the extent that the fibers 9 detach from the plastic matrix 8.

Thereafter, the fibers 9 are separated from the plastic particles 8 in a third section c, which is formed substantially by the separation installation 13.

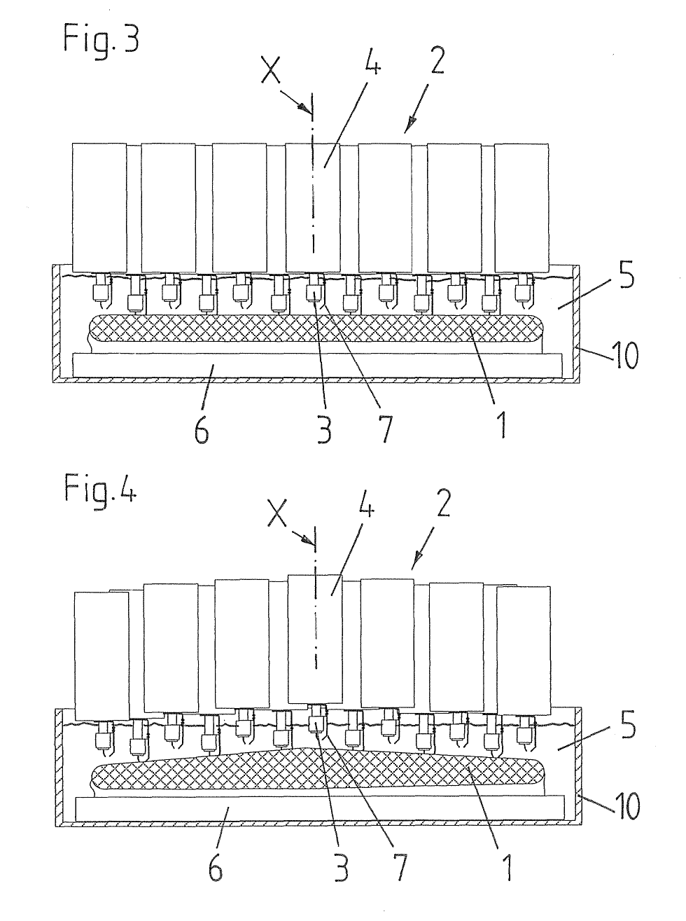

The device has a machine controller (not shown) for controlling the fragmentation process, by means of which the high voltage electrodes 3 are shifted automatically along their shifting axes x, during the passage of the material piece 1 past the high voltage electrodes 3 and the generation of high voltage punctures through the material piece 1, in such a way that each of them follows the contour of the material piece 1 at a certain distance. As seen from FIG. 1 and FIGS. 3 and 4, which show vertical sections through the device along the line B-B of FIG. 1 during fragmentation of a plate-type component 1 (FIG. 3) and a profiled component 1 (FIG. 4), this distance adjustment is not carried out row-wise but individually for each high voltage electrode 3, such that the matrix 2 of high voltage electrodes 3 fits to the respective contour of the material piece 1 to be fragmented, in material passage direction S as well as transversally to the material passage direction.

The installation controller also verifies continuously for each high voltage electrode 3, if a material piece 1 is located within a certain distance range to the respective high voltage electrode 3, and charges the respective high voltage electrode 3 with high voltage punctures only if a material piece 1 is located within this distance range.

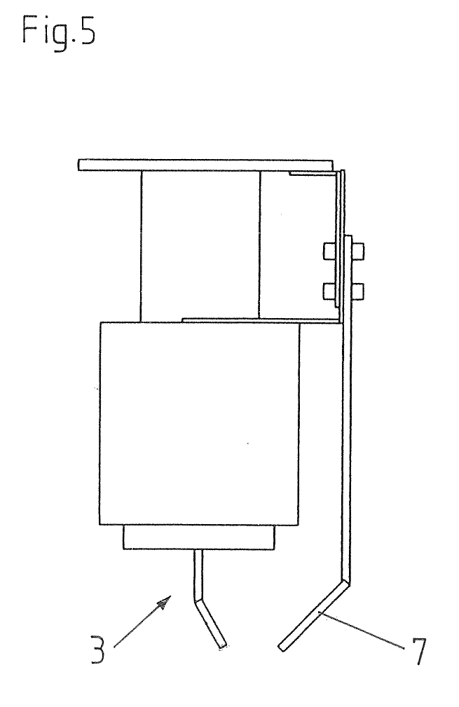

As can be seen in FIG. 5, which shows one of the electrode arrangements of the device in lateral view, each of the high voltage electrodes 3 of the matrix 2 has an own counter electrode 7 which is grounded and which is shiftable along the shifting axis X together with the respective high voltage electrode 3 and it is arranged relatively to the respective high voltage electrode 3 in such a way that in the shown operation high voltage punctures between the high voltage electrode 3 and the counter electrode 7 attributed to it are generated through the material piece 1 by charging the respective high voltage electrode 3 with high voltage pulses.

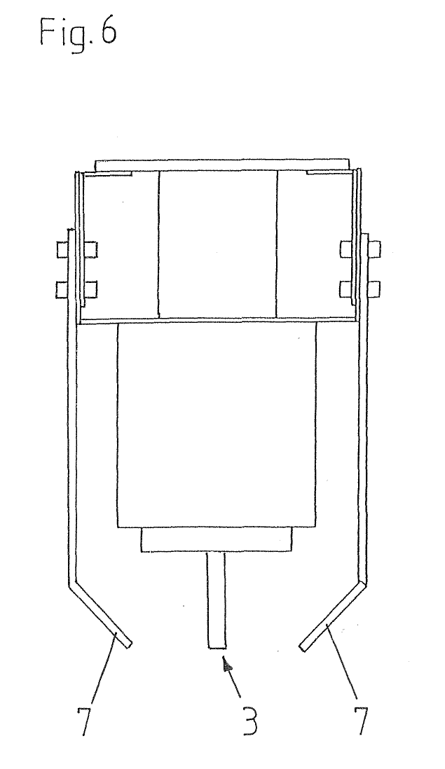

FIG. 6 shows a lateral view of a high voltage electrode 3 which differs from the one shown in FIG. 5 substantially in that it has two identical counter electrodes 7 which are arranged facing one another in a mirrored way. A further difference is that this high voltage electrode 3 has a straight electrode tip.

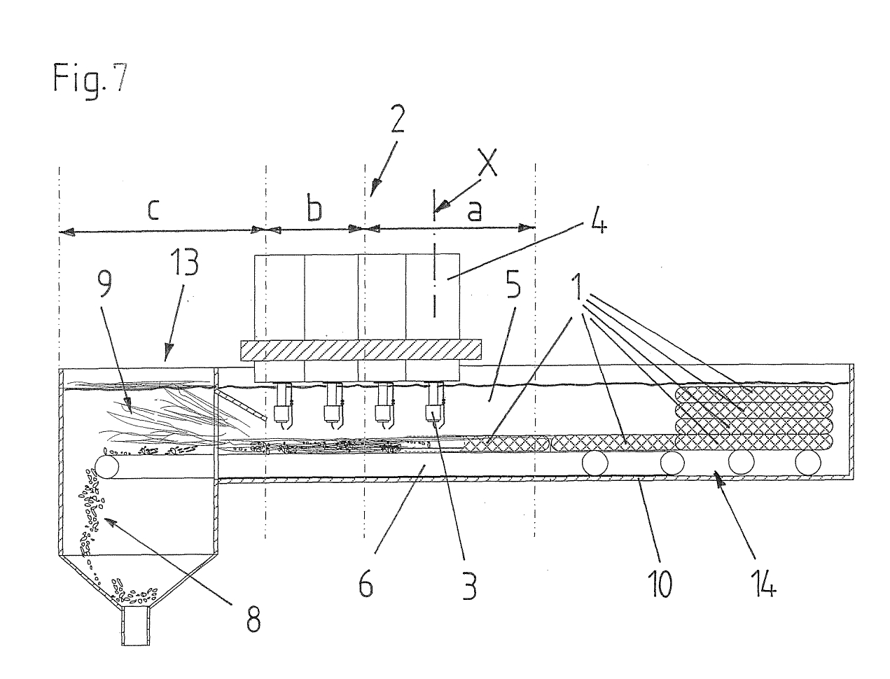

FIG. 7 shows a second device according to the invention for fragmenting large material pieces 1 made of fiber composites in a vertical section along the material passage direction S.

This device differs from the first device according to the invention described above only in that it has a four-row matrix 2 of high voltage electrodes 3 and doesn't have a transversal roller ramp 11 with a hold-down device 12 for supplying the material piece 1 to fragment, but instead has a roller table 14 arranged on the bottom of the basin 10 (which is extended here). The transport planes of this roller table 14 and the conveyor belt 6 coincide, such that the material pieces 1 are guided to the process zone and through it without changing direction and without deformation.

As can be seen, the material pieces 1 to fragment are provided on the roller table 14 in a staple and are supplied to the process zone one after the other.

While in the present application preferred embodiments of the invention are described, it is clearly noted that the invention is not limited thereto and may be executed in other ways within the scope of the now following claims.

1. Method for fragmenting and/or weakening a material piece by means of high voltage discharges, comprising the steps of:
a) providing a matrix of multiple high voltage electrodes, which are shiftable independently from one another along particularly parallel, particularly vertically oriented shifting axes, and each of which is attributed to a common or an own high voltage generator, by means of which they are chargeable with high voltage pulses;
b) providing a material piece to be fragmented and/or weakened, immersed in a process liquid;
c) guiding the material piece past the matrix of high voltage electrodes in a direction running at an angle, particularly substantially perpendicular, to the shifting axes (X) of the high voltage electrodes; and
d) generating high voltage punctures through the material piece during the guiding of the latter past the matrix of high voltage electrodes by charging the high voltage electrodes with high voltage pulses,
wherein during the guiding of the material piece past the matrix of high voltage electrodes and the generation of high voltage punctures through the material piece, the high voltage electrodes are each shifted along their shifting axes in such a way that in each case they follows the contour of the material piece at a certain distance or follows the contour of the material piece in contact with the surface of the latter and during this time are immersed in the process liquid.

2. Method according to claim 1, wherein, for guiding the material piece past the matrix of high voltage electrodes, it is guided past it substantially horizontally, particularly is shifted horizontally.

3. Method according to claim 2, wherein the material piece is guided past the matrix of high voltage electrodes by means of a transport installation, particularly by means of a conveyor belt or a conveyor chain.

4. Method according to claim 3, wherein the transport installation serves as counter electrode to the high voltage electrodes and high voltage punctures between the high voltage electrodes and the conveyor belt are generated through the material piece by charging the high voltage electrodes with the high voltage pulses.

5. Method according to claim 1, wherein at least one own counter electrode is attributed to each high voltage electrode, which is shifted along the shifting axis together with the respective high voltage electrode and is arranged relatively to the respective high voltage electrode in such a way that high voltage punctures between the high voltage electrodes and the counter electrode are generated through the material piece by charging the respective high voltage electrode with the high voltage pulses.

6. Method according to claim 1, wherein an own high voltage generator is attributed to each high voltage electrode, by means of which it is charged with high voltage pulses independently from the other high voltage electrodes.

7. Method according to claim 6, wherein the high voltage generator in each case is firmly connected to the respective high voltage electrode and is shifted along the shifting axis together with it.

8. Method according to claim 1, wherein the distance of each high voltage electrode to the contour of the material piece is continuously measured, particularly in a contactless way, and the high voltage electrode is shifted along the shifting axis in such a way that the measured distance corresponds to a certain target distance.

9. Method according to claim 1, wherein it is continuously verified for each high voltage electrode, particularly in a contactless way, if a material piece is located within a certain distance range to the respective high voltage electrode, and wherein the respective high voltage electrode is only charged with high voltage pulses when the verification results in that a material piece is located within this distance range.

10. Method according to claim 1, wherein a material piece is fragmented and/or weakened, the extension of which is larger in a passing direction, particularly many times larger, than the extension of the matrix of high voltage electrodes in the passing direction.

11. Method according to claim 1, wherein the material piece is a component or a piece of a component made of a fiber composite, particularly of glass-fiber-reinforced plastic or of carbon-fiber-reinforced plastic.

12. Method according to claim 10, wherein the material of the material piece during passage of the material piece past the matrix of high voltage electrodes is weakened by charging with high voltage punctures by means of at least a part of the high voltage electrodes of the matrix, wherein the weakened material is deflected under deformation of same, particularly in such a way that it is subsequently guided further substantially in horizontal direction, and wherein the deflected weakened material is fragmented by further charging with high voltage punctures.

13. Method according to claim 12, wherein the further charging of the deflected weakened material with high voltage punctures for fragmenting the material is also done by means of a part of the high voltage electrodes of the matrix.

14. Method according to claim 12, wherein the material piece is supplied with a first movement direction which is inclined downwards to the matrix of high voltage electrodes and, while passing past the matrix of high voltage electrodes after weakening by charging with high voltage punctures by means of at least a part of the high voltage electrodes of the matrix, the material of the material piece is deflected under deformation of same, such that after the deflection it is transported further in a second movement direction which is less inclined downwards, particularly in a substantially horizontal movement direction.

15. Method according to claim 3, wherein the deflection is carried out by means of the transport installation.

16. Method according to claim 11, wherein the fiber composite is fragmented in such a way that the plastic content are separated from the fibers, and particularly wherein subsequently the fibers are separated entirely or partially by separation from the plastic content.

17. Device for fragmenting and/or weakening a material piece by means of high voltage discharges the device comprising:
a matrix of multiple high voltage electrodes, which are shiftable independently from one another along particularly parallel, particularly vertically oriented shifting axes,
wherein the high voltage electrodes are adapted to be charged with high voltage pulses, thereby generating high voltage punctures through the material piece, while the material piece is immersed in a process liquid and guided past the matrix in a direction running at an angle, particularly substantially perpendicular, to the shifting axes of the high voltage electrodes,
wherein during the guiding of the material piece past the matrix of high voltage electrodes and the generation of high voltage punctures through the material piece, the high voltage electrodes are further adapted to being shifted along their shifting axes in such a way that in each case they follow the contour of the material piece at a certain distance or follows the contour of the material piece in contact with the surface of the latter and while being immersed in the process liquid.

18. Device according to claim 17, wherein an own high voltage generator is attributed to each of the high voltage electrodes, by means of which the latter can be charged with high voltage pulses independently from the other high voltage electrodes.

19. Device according to claim 18, wherein the high voltage generator in each case is firmly connected to the high voltage electrode and is shifted along the shifting axis together with it.

20. Device according to claim 17, further comprising a machine controller by means of which, in operation as intended during the passage of the material piece past the matrix of high voltage electrodes and the generation of high voltage punctures through the material piece, the high voltage electrodes can be shifted automatically along their shifting axes in such a way that each of them follows the contour of the material piece at a certain distance or each of them follows the contour of the material piece in contact with the surface of the material piece.

21. Device according to claim 20, wherein the machine controller is adapted to verify continuously for each high voltage electrode, in operation as intended during the passage of the material piece past the matrix of high voltage electrodes, if a material piece is located within a certain distance range to the respective high voltage electrode, and charges the respective high voltage electrode with high voltage pulses only if the verification results in that a material piece is located within this distance range.

22. Device according to claim 17, further comprising a transport installation, particularly formed as a conveyor belt or conveyor chain, arranged in a basin that can be filled with a process liquid, by means of which a material piece to be fragmented and/or weakened, immersed into a process liquid, can be guided past the matrix of high voltage electrodes, in operation as intended, in a transport direction substantially perpendicular to the shifting axes of the high voltage electrodes.

23. Device according to claim 22, further comprising a supply installation, particularly formed as a roller ramp, by means of which the material piece to be fragmented and/or weakened is supplied into an area formed between the transport installation and the matrix of high voltage electrodes in a supply direction which is inclined downwards.

24. Device according to claim 23, wherein the supply direction (S1) of the supply installation is in a vertical plane at an angle with respect to the transport direction (S2) of the transport installation, particularly at an angle greater than 15°.

25. Device according to claim 23, further comprising a hold-down device, particularly with one or more pressure rollers, by means of which the material piece to be fragmented and/or weakened is secured against takeoff from the supply installation during the supply, in such a way that, in order to entirely pass the area between the transport installation and the matrix of high voltage electrodes, it is deformed by the transport installation in this area as a result of a deflection.

26. Device according to claim 22, wherein the transport device serves as counter electrode to the high voltage electrodes in operation as intended, and high voltage punctures between the high voltage electrodes and the conveyor belt can be generated through the material piece to be fragmented and/or weakened by charging the respective high voltage electrode with the high voltage pulses.

27. Device according to claim 17, wherein an own counter electrode is attributed to each high voltage electrode, which can be shifted along the shifting axis (X) together with the respective high voltage electrode and is arranged relatively to the respective high voltage electrode in such a way that in operation as intended high voltage punctures between the high voltage electrode and its attributed counter electrode can be generated through the material piece to be fragmented and/or weakened by charging the respective high voltage electrode with the high voltage pulses.

28. Device according to claim 17, further comprising, arranged downstream of the matrix of high voltage electrodes, as seen in a transport direction of the transport installation, a separation installation for separating fiber-type and particle-type fragmentation products.

29. Device according to claim 17, wherein the matrix of high voltage electrodes is formed by multiple rows of high voltage electrodes, which are arranged one after the other as seen in a direction of passage of the material piece, wherein the high voltage electrodes are each shifted in case the rows are arranged directly one after the other.

30. Use of the device according to claim 17 for fragmenting and/or weakening of fiber composites, particularly of glass-fiber-reinforced plastic or of carbon-fiber-reinforced plastic.
